(19) United States
(12) Patent Application Publication
(10) Pub. No.: US 2005/0230530 A1
(43) Pub. Date: Oct. 20, 2005

(54) Closed wing

(75) Inventors: Andrey Igorevich Akaro, Moscow (RU); Andrey Borlsovich Pepelin, Moscow (RU); Anatoly Mikhailovich Zelinsky, St Petersburg (RU); Mikhail Mikhailovich Medvedev, Zhukovsky (RU)

Correspondence Address: Ilya Zborovsky, 6 Schoolhouse Way, Dix Hills, NY, 11746, US

(73) Assignee: OBSCHESTVO S OGRANICHENNOI OTVETSTVENNOSTYU MIDER, Moscow (RU)

(21) Appl. No.: 10/514,654

(22) PCT Filed: Apr. 21, 2003
(86) PCT No.: PCT/RU03/00185

§ 371 Date: Nov. 13, 2004

(30) Foreign Application Priority Data
May 18, 2002 (RU) 2002112900

(51) Int. Cl. B64C 27/22

(52) U.S. Cl. 244/35 R

(57) ABSTRACT

An inventive wing (1) comprises an axis symmetrical plate, whose edges are embodied such that they are sharp. Said plate is provided with two rounded bosses arranged symmetrical with respect to the center thereof. Each boss is twisted with respect to the axis thereof. The plate can be provided with four rounded bosses symmetrically arranged with respect to the axis thereof. Said wing carries out motion and oscillations with respect to air when a lifting force and a horizontal power are provided. The aim of said invention is to increase aerodynamic performance.

### TECHNICAL FIELD

The invention relates to the field of aviation and can be used in an aerodynamic lifting-thrusting propulsion device, mountable on a flying apparatus for generation of a lifting force and a horizontal thrust.

### BACKGROUND ART

A blade of a carrying screw of a helicopter is known, which during its rotation generates a lifting force and a horizontal thrust force during flight of the helicopter (W. Johnson “Theory of Helicopter”, V. I, M, “Mir”, 1983, P. 17).

A blade of a carrying screw of a helicopter is known, which generates during its rotation a lifting force and a horizontal thrust. One of the edges of the blade is formed wedge-shaped (U.S. Pat. No. 3,706,430, cl. 244/35, 1972).

It is possible to generate a lifting force and a horizontal thrust in an aerodynamic lifting-thrusting propulsion device by wings which move along a circumference and simultaneously synchronously rotate in an opposite direction, which generates a rectilinear (without rotation) movement of the wings relative to air and provides a uniform distribution of aerodynamic forces over a wing, resulting in a high efficiency of a lifting force, while a generation of the horizontal thrust is provided by oscillations of the wings synchronously with their rotation relative to mutually perpendicular axes, which are perpendicular to an axis of movement of the wing along the circumference.

For performing such a complicated movement, a special shape of the wings is required. During this movement, the wing which generates an aerodynamic force runs onto air successively with all its sides. Conventional blades of the carrying screw of the helicopter are not suitable, since they are especially calculated for meeting of the wing with air by its one side.

### DISCLOSURE OF THE INVENTION

A basis of the invention is an objective of creating a wing for generation of a lifting force and a horizontal thrust by means of which a generation of the lifting force and the horizontal thrust during running onto air successively of all its sides and oscillations relative to mutually perpendicular axes that are perpendicular to the axis of movement of the wing along a circumference are provided with a maximum aerodynamic efficiency.

The objective of providing a wing for generation of a lifting force and a horizontal thrust is achieved in that the wing for generation of a lifting force and a horizontal thrust, in accordance with the invention, is made in form of an axis-symmetrical plate, whose edges are formed sharp, and the wing has a possibility of movement along a circumference, a synchronous rotation in an opposite direction, and synchronous oscillations relative to the mutually perpendicular axes, that are perpendicular to the axis of movement along the circumference.

The formation of the wing in the form of the axis-symmetrical plate, whose edges are formed sharp, makes possible for such a thin flat plate with sharp edges during the generation of a rectilinear movement and oscillations to provide a uniform running onto air with all its sides and a low aerodynamic resistance.

The possibility of movement of the wing along the circumference, its synchronous rotation in an opposite direction generates a rectilinear movement of the wing relative to air and provides a uniform distribution of aerodynamic forces over the wing, which leads to a high efficiency of the lifting force.

The possibility of the synchronous oscillations of the wing relative to the mutually perpendicular axes that are perpendicular to the axis of movement along the circumference provides a generation of the horizontal thrust with a high aerodynamic efficiency.

The plate can be formed with two rounded bosses which are located symmetrically relative to its center, wherein each boss is twisted relative to an axis of its symmetry, which leads to a generation of a moment that enhances the oscillations of the wing relative to one axis and provides a reduction of forces used for its oscillations.

The plate can be formed with four rounded bosses which are located symmetrically relative to its center, and wherein each boss is twisted relative to the axis of its symmetry, which leads to a generation of a moment that enhances oscillations of the wing relative to the mutually perpendicular axes and provides a reduction of forces used for its oscillations.

### BRIEF DESCRIPTION OF THE DRAWINGS

FIG. 1 shows a scheme of movement of a wing for generation of a rectilinear and oscillating movements in an aerodynamic lifting-thrusting propulsion device;

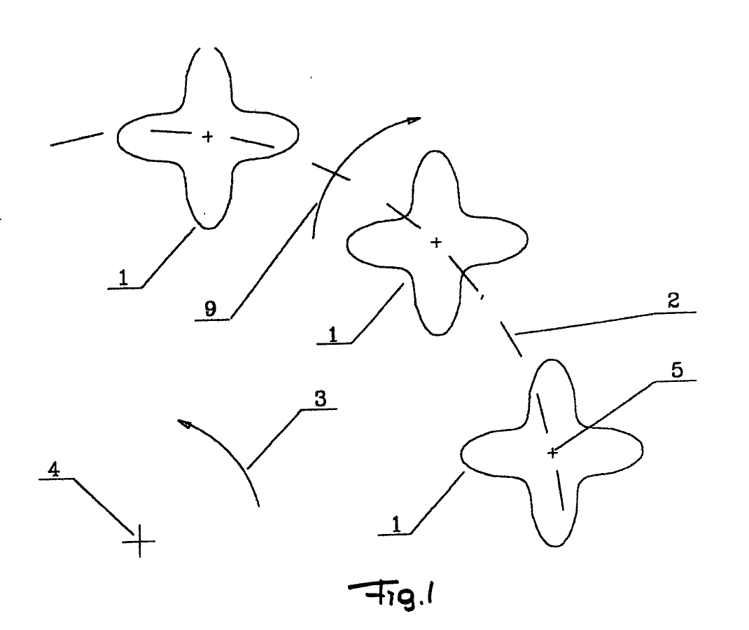

FIG. 2 is a top view on the wing without bosses;

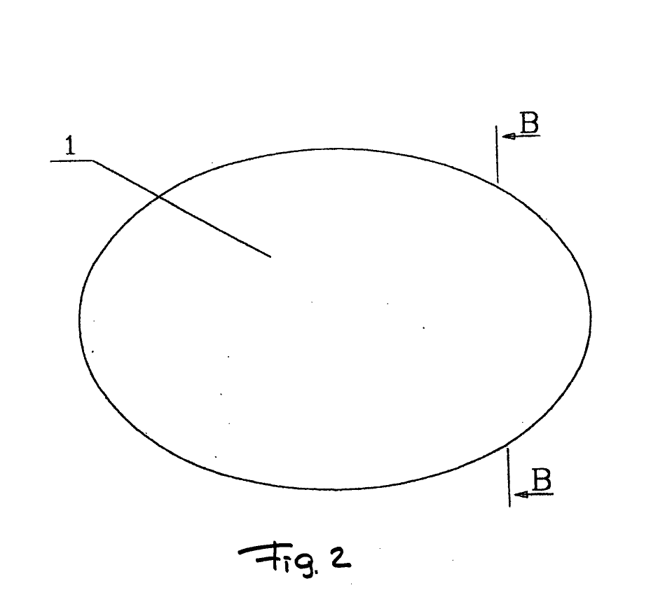

FIG. 3 is a section along the line B-B in FIG. 2;

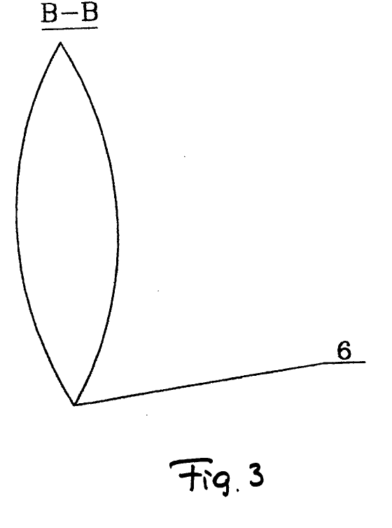

FIG. 4 is a top view on the wing with two bosses;

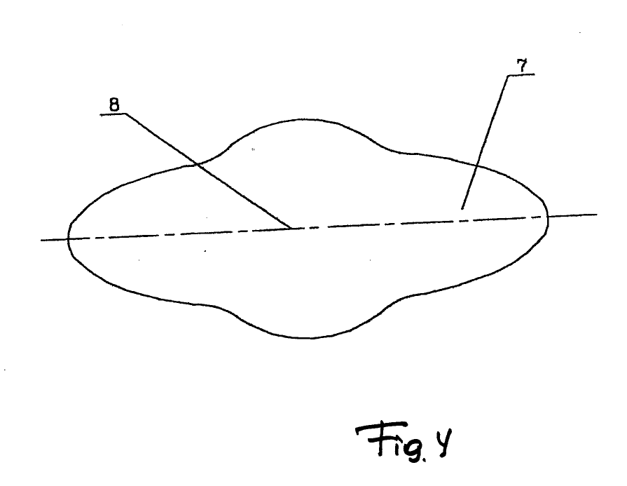

FIG. 5 is a top view on a wing with four bosses;

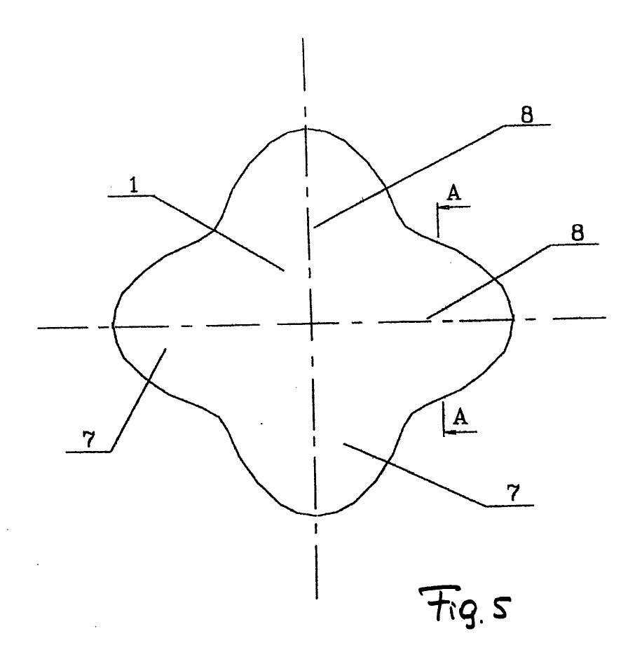

FIG. 6 is a section along the line A-A in FIG. 5;

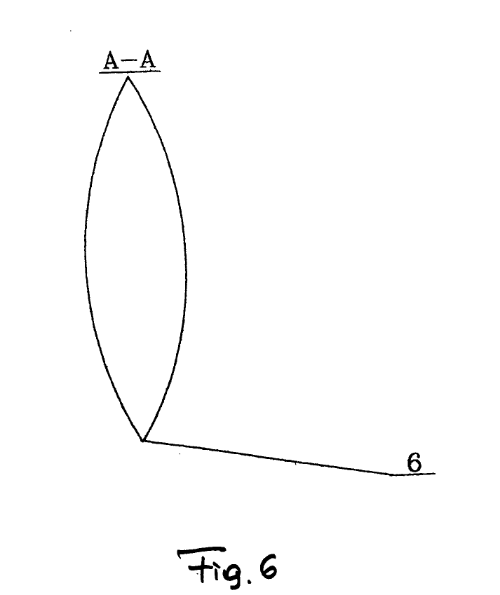

FIG. 7 is a side view on the wing with four twisted bosses;

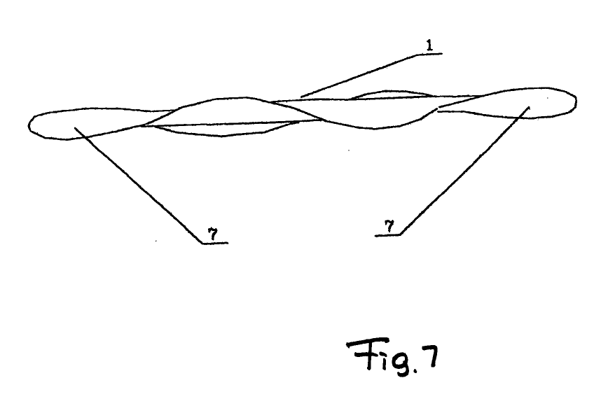

FIG. 8 is a scheme of oscillations of the wing during its movement along a circumference.

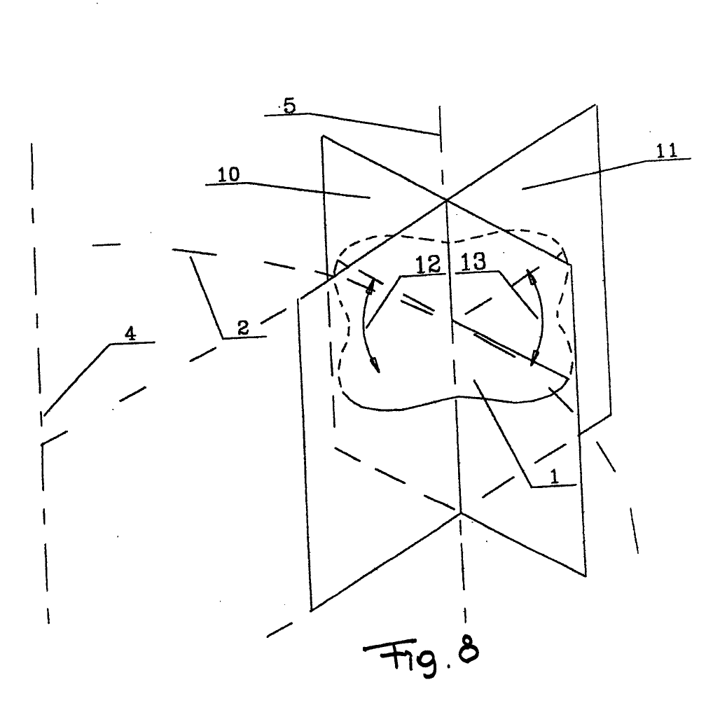

### BEST MODE OF CARRYING OUT THE INVENTION

A wing 1 moves along a circumference 2 in a direction, which is shown with an arrow 3, relative to an axis of movement 4. The wing 1, synchronously with the movement along the circumference 2, rotates in an opposite direction relative to an axis of rotation 5, which is parallel to the axis of movement 4 in a direction shown by an arrow 9. As a result, a rectilinear movement of the wing 1 is generated. The wing 1 also performs, synchronously with its rotation, oscillations relative to two mutually perpendicular axes that are perpendicular to the axis of movement along the circumference and are located respectively in two mutually perpendicular planes 10 and 11, which intersect one another along the axis of rotation 5. The directions of these oscillations are conditionally shown by arrows 12 and 13, respectively in the planes 10 and 11. Since wing 1 moves rectilinearly, the generated lifting force is distributed on it uniformly, that provides a high energy efficiency. During the oscillations of the wing 1 relative to the mutually perpendicular axes, that are perpendicular to the axis of movement 4 along the circumference, together with the lifting force also a horizontal thrust is generated, wherein the distribution of the aerodynamic force on the wing 1 remains close to uniform.

The wing 1 is made in the form of an axis-symmetrical plate, whose edges 6 are formed sharp.

The wing 1 has a possibility of movement along a circumference, a synchronous rotation in an opposite direction, and synchronous oscillations relative to mutually perpendicular axes, that are perpendicular to the axis of movement 4 along the circumference 2.

The plate of the wing 1 can be formed with two rounded bosses 7 which are symmetrically located relative to its center, wherein each boss 7 is twisted relative to its axis of symmetry 8.

The plate of the wing 1 can be formed with four rounded bosses 7 which are located symmetrically relative to its center, wherein each boss 7 is twisted relative to its axis of symmetry 8.

The formation of the wing 1 in form of an axis-symmetrical plate, whose edge 6 are formed sharp, makes possible for such thin flat plate with sharp edges, during the generation of a rectilinear movement and oscillation, to provide a uniform running onto air of all its sides and a low aerodynamic resistance.

The possibility of movement of the wing 1 along the circumference 2, its synchronous rotation in an opposite direction, generates the rectilinear movement of the wing 1 relative to air and provides a uniform distribution of aerodynamic forces over the wing 1, that leads to a high efficiency of the lifting force.

The possibility of synchronous oscillations of the wing 1 relative to the mutually perpendicular axes which are perpendicular to the axis of movement 4 along the circumference 2, provides generation of a horizontal thrust with a high aerodynamic efficiency.

The formation of the plate with two rounded bosses which are symmetrically located relative to its center, and twisting of each boss 7 relative to its axis of symmetry 8, leads to a generation of a moment which enhances the oscillations of the wing relative to one axis and provides a reduction of forces used for its oscillations.

The formation of the plate with four rounded bosses 7 which are located symmetrically relative to its center and twisting of each boss 7 of the wing 1 relative to its axis of symmetry 8 leads to generation of a moment which enhances the oscillations of the wing relative to the mutually perpendicular axes and provides a reduction of forces used for its oscillation.

Angles of twisting of the bosses are selected from a condition, that a total aerodynamic resistance of the wing with a twisted bosses increases an aerodynamic resistance without twisting not more than by a standard calculated tolerance (20%).

The proposed wings makes possible to perform a flight of a flying apparatus with a high energy efficiency.

### INDUSTRIAL UTILITY

The present invention can be used most successfully as a wing for generation of a lifting force and a horizontal thrust in an aerodynamic lifting-thrusting propulsion device, mounted on a flying apparatus.

1-3. (canceled)

4. A wing for generation of a lifting force and a horizontal thrust, comprising an axis symmetrical plate, said plate having edges which are sharp, said plate being formed so that it is movable along a circumference, synchronously rotatable in an opposite direction, and oscillating relative to mutually perpendicular axes.

5. A wing as defined in claim 4, wherein said plate has two rounded bosses which are located symmetrically relative to its center, each of said bosses being twisted relative to its axis of symmetry.

6. A wing as defined in claim 4, wherein said plate has four rounded bosses which are located symmetrically relative to its center, each of said bosses being twisted relative to its center of symmetry.
